(19) United States
(12) Patent Application Publication
(10) Pub. No.: US 2003/0025995 A1
(43) Pub. Date: Feb. 6, 2003

(54) Autostereoscopie

(76) Inventors: Peter-Andre Redert, Eindhoven (NL); Winfried Antonius Henricus Berkvens, Eindhoven (NL)

Correspondence Address: U.S. Philips Corporation, 580 White Plains Road, Tarrytown, NY, 10591, US

(21) Appl. No.: 10/201,678

(22) Filed: Jul. 23, 2002

(30) Foreign Application Priority Data
Jul. 27, 2001 (EP) 01202870.0

(51) Int. Cl. G02B 27/22

(52) U.S. Cl. 359/464; 359/462; 359/463; 359/466

(57) ABSTRACT

Autostereoscopic image display apparatus comprising a display device including a 3D image source emitting lightbeams carrying pixels to a lenticular screen having an array of lenses for displaying said 3D image, a parallax barrier being located between the image source on the one hand and the lenticular screen on the other hand, said parallax barrier being provided with an array of light transmissive slits for transmitting said lightbeams to the array of lenses of said lenticular screen, and a viewpoint tracker detecting right and left eye positions and tracking said display device therewith. To allow a multiple number of observers to perceive 3D images simultaneously and independent from viewpoint movement and/or position, said viewpoint tracker is used to control the slits of the parallax barrier to vary the incidence of said lightbeams into the lenses to effect an angle of refraction within said lenses causing the outgoing lightbeams carrying pixels of said right and left eye views to converge into at least one distinct right and one distinct left eye view focus, respectively, coinciding with the eye positions of said observers.

The invention relates to an autostereoscopic image display apparatus comprising a display device including an image source emitting lightbeams carrying pixels of right and left eye views of a 3D image to a lenticular screen having an array of lenses for displaying said 3D image, a parallax barrier being located between the image source on the one hand and the lenticular screen on the other hand, said parallax barrier being provided with an array of light transmissive slits separated by opaque regions for transmitting said lightbeams to the array of lenses of said lenticular screen, and a viewpoint tracker detecting right and left eye positions and tracking said display device therewith.

The invention also relates to a display for use in such autostereoscopic image display system.

Such autostereoscopic image display system is known in various forms of implementation and is aimed at a recreation of the two different perspectives of a 3D view or image as perceived by the two human eyes without the need for viewing aids to be worn by the observer. The viewpoint tracker is used therein to dynamically align the point of recreation with the viewpoint or observer position. The two different perspectives of a 3D view, also being referred to as stereoscopic pair of images, allow the brain to assess the distance to various objects in a scene and to provide for a 3D view impression. However, the autostereoscopic image display systems known sofar suffer from various shortcomings, which are specific to the method used to supply the different views to the eyes.

For example, the autostereoscopic image displays system known from U.S. Pat. No. 5,991,073 creates ‘viewing regions’, i.e. regions of space in front of the lenticular screen, in which a single two dimensional (2D) image view is visible across the whole of the active area of the screen by one eye. When an observer is situated such that the right eye R is in a right viewing region and the left eye L is in the left viewing region, a stereoscopic pair of images is seen and a 3D image can be perceived. However, this known autostereoscopic displays system allows only one observer to perceive 3D images correctly. Furthermore the brightness of the 3D images perceived reduces with an increasing number of observers.

It is an object of the invention to provide an autostereoscopic image display system as described in the opening paragraph allowing a multiple number of observers to perceive 3D images simultaneously and independent from viewpoint movement and/or position. This object is achieved in an autostereoscopic image display system according to the invention, which is characterized by said viewpoint tracker controlling the slits of the parallax barrier to vary the incidence of said lightbeams into the lenses to effect an angle of refraction within said lenses causing the outgoing lightbeams carrying pixels of said right and left eye views to converge into at least one distinct right and one distinct left eye view focus, respectively, coinciding with said detected right and left eye positions.

By applying this measure, the parallax barrier together with the lenses of the lenticular screen function as directivity optics being controlled by the viewpoint tracker to vary the transmission of the light beams through the slits of the parallax barrier into the individual lenses of the lenticular screen, such that each of the right and left eye views is emitted directly into the corresponding eyes of one or more viewers or observers as detected by the viewpoint tracker, irrespective of their position and eventual (head) movements. Furthermore, unlike the above referenced prior art autostereoscopic image display system in which the pixel carrying light beams spread over many viewing regions, the lightbeams carrying pixels of said right and left eye views are respectively focused according to the invention one to one at the right and left eyes of the observers individually. This observer individual supply of 3D images avoids the brightness of a perceived 3D image from being dependent on the number of observers.

An embodiment of an autostereoscopic image display system according to the invention is characterized by the slits of the parallax barrier having subpixel width. By applying this measure, the lightbeams traversing the individual slits of the parallax barrier each carry part of the same pixel, therewith allowing to provide several observers simultaneously with the same pixel information and consequently with the same 3D image.

An embodiment of an autostereoscopic image display system according to the invention is characterized by the lenses of the lenticular screen having a width substantially greater than the width of the slits of the parallax barrier. Each lens is therein used for refraction/focussing of several lightbeams to several different observers simultaneously, resulting in a cost effective implementation.

To avoid loss of image resolution, such autostereoscopic image display system according to the invention is preferably characterized by the lenses of the lenticular screen having a width corresponding substantially to 0.3-3 times pixel width.

A proper alignment of the slits of the parallax barrier with the lenses of the lenticular screen is obtained with an autostereoscopic image display system according to the invention, which is characterized by the parallax barrier being provided with a number of slits per lens width in the order of 10 to 1000.

An autostereoscopic image display system according to the invention is characterized by the array of lenses of the lenticular screen forming vertical columns of lenses mutually optically separated by opaque vertical stripes each having a width smaller than the width of the lenses of the lenticular screen. The opaque vertical stripes prevent lightbeam aberrations from occurring at the rims of the lenses, while leaving the brightness of the outgoing light untouched, as most of this outgoing light is emitted from the center part of the lens. Furthermore, the opaque vertical stripes may be used for strengthening the construction of the lenticular screen, e.g. for mutually gluing the columns of lenses. These rims may well be painted dark to prevent reflection of light at the viewer side.

An autostereoscopic image display system is preferably characterized by the lenses within the array of lenses of the lenticular screen having a hemispherical cross section, which is easy to manufacture and provides for a robust construction.

An autostereoscopic image display system according to the invention is characterized by a Fresnel lens being disposed between said image device and said parallax barrier. This measure allows for the image source to use divergent light, which is then refracted resulting in collimated light.

An autostereoscopic image display system according to the invention is characterized in that the image source comprises a collimated backlight source. The use of collimated light for the transmission of the lightbeams carrying pixels of right and left eye views of a 3D image to a lenticular screen makes the use of a Fresnel lens redundant.

Such collimated backlight source can be derived e.g. from a laser light source and makes it possible to use socalled thick lenses having a viewing angle greater than 100 degrees.

The parallax barier of an autostereoscopic image display system according to the invention may be an LCD type of a Polymer LC/gel type barrier allowing for easy implementation.

Autostereoscopic image display system according to the invention is characterized by the array of lenses of said lenticular screen forming a horizontal diffusor with vertical columns of lenses, said display device also comprising a vertical diffuser consisting of a number of horizontal columns of lenses having a width substantially equal to the width of the lenses of the lenticular screen forming said horizontal diffusor, said vertical diffuser being positioned either behind or in front of said horizontal diffuser. Where the horizontal diffusor in combination with the tracked parallax barrier is used as directivity optics to obtain eye selective time multiplex projection of the two views of a 3D image, said vertical diffuser is fixed and can be used to narrow projection in vertical direction. The brightness of projection for viewpoints within a certain vertical range is therewith increased at the expense of the brightness of projection for viewpoints beyond said certain vertical range. Preferably this range is chosen to cover substantially all most likely vertical viewpoint positions.

An autostereoscopic image display system according to the invention is characterized by said viewpoint tracker detecting eye positions of various viewers, the individual lenses of the lenticular screen receiving lightbeams from a number of slits determined by the number of detected viewers. Each detected eye should be supplied with the image information of a complete picture. The lightbeams passing the slits of the parallax barrier are carrying samples of the pixels constituting the complete picture. To avoid loss of image information, the number of slits Sn allocated to one eye should be sufficient to have at least one sample per each pixel of said picture transmitted through the barrier to the lenses of the lenticular screen. This means that loss of image information for N viewers is avoided if the parallax barrier is provided with 2*N*Sn slits. This measure avoids loss of image resolution while allowing to provide all observers individually with complete 3D images.

An autostereoscopic image display system according is characterized by the right and left eye views of said 3D image being emitted by the image source in time multiplex. In this embodiment, the viewpoint tracker performs viewpoint detection and display tracking for each eye preferably within a certain timeframe periodically occurring within a sequence of time frames. These alternately timeframes accommodate the right and left eye view data and are chosen sufficiently short to avoid flickering of the perceived images on the one hand and to allow the viewpoint tracker to follow adequately normal head movements.

An embodiment of an autostereoscopic image display system according to the invention is characterized by viewer selective means controlling the parallax barrier to block the transmission of pixel carrying lightbeams to one or more predetermined viewers. This measure can be used in e.g. pay TV systems or the like, in which non-subcribers can be denied access to certain charged 3D images or video pictures.

An embodiment providing for the use of the lenticular screen for displaying multi viewer, multi programme 3D TV is characterized by said image source providing various 3D TV programs in time multiplexed 3D images, each 3D image thereof being projected at the right and left eyes viewpoints of a number of observers by an angle of refraction within said lenses controlled by said viewpoint tracker through an adjustment of the slits of the parallax barrier to vary the incidence of said lightbeams into the lenses.

The invention further relates to a display device for use in an autostereoscopic image display system according to the invention.

The above object and features of the present invention will be more apparent from the following description of the preferred embodiments with reference to the drawings, wherein:

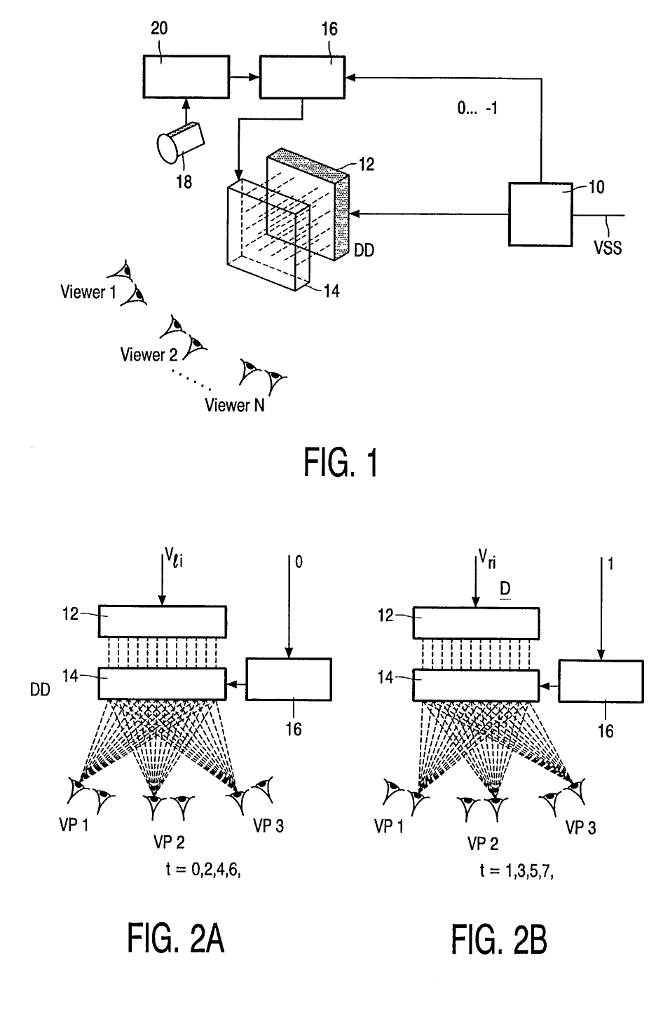

FIG. 1 shows a block diagram of an autostereoscopic image display system according to the invention;

FIGS. 2A and 2B show the 3D image reconstruction obtained with the directivity optics of a display device used in an autostereoscopic image display system according to the invention;

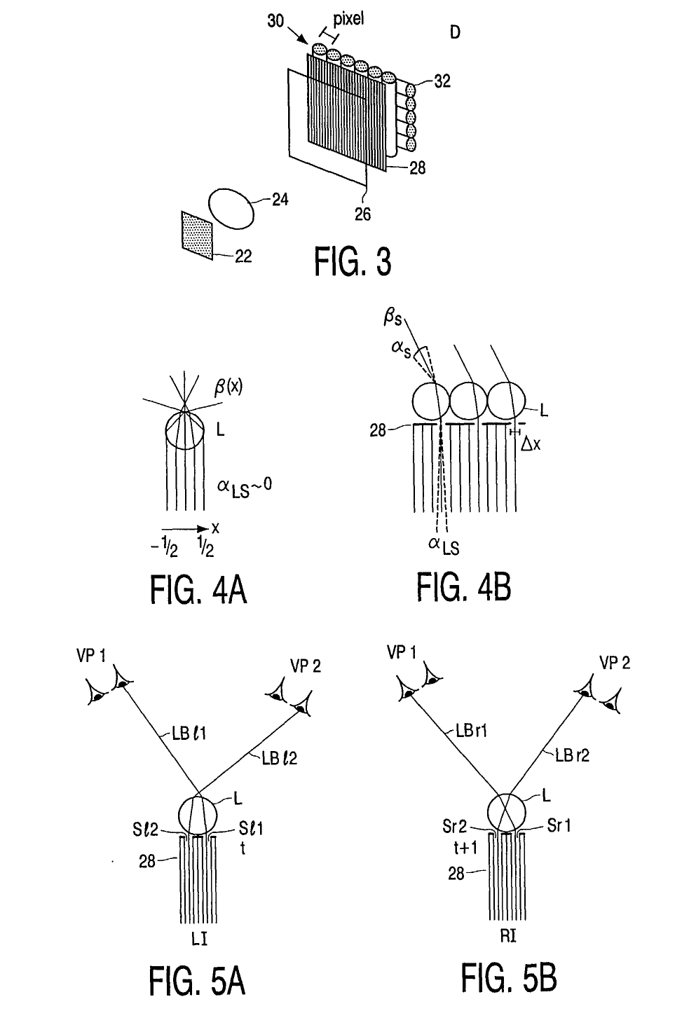

FIG. 3 shows directivity optics used in an autostereoscopic image display system according to the invention;

FIGS. 4A and 4B shows the light beam refraction in a lens of the lenticular screen used in a display device according to the invention;

FIGS. 5A and 5B show in more detail the refraction of several lightbeams carrying pixels of various views, which are projected to different viewers sharing one same lens;

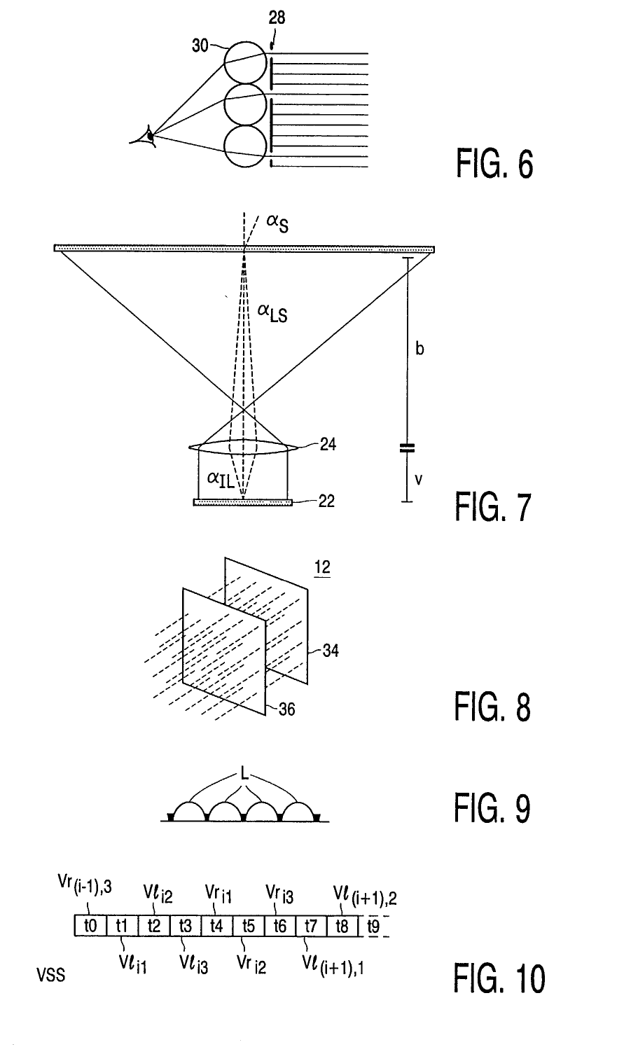

FIG. 6 shows the operation of the directivity optics in displaying various pixels of a single eye view in an autostereoscopic image display system according to the invention;

FIG. 7 shows in more detail an image source using a rear projector for use in a display device according to the invention;

FIG. 8 shows an LCD screen converting uniformly bright collimated light into collimated light with spatial intensity variations.

FIG. 9 shows an alternative embodiment of the lens shape of the lenticular screen in a display device according to the invention;

FIG. 10 shows a signal frame structure comprising sequential time slots for a time multiplex transmission of several 3D images.

In the Figures, identical parts are provided with the same reference numbers.

FIG. 1 shows a block diagram of an autostereoscopic image display system according to the invention capable of displaying M original 3D video or TV programmes in a time multiplex composite input video stream signal VSS to n=1, 2, . . . or N observers on an observer and image selective basis, as will be explained in more detail hereinafter. Each of those M original 3D video or TV programmes entering the display system is composed of e.g. K original 3D images formed by 2D left and right eye views, each of those 2D left and right eye views being focused at the corresponding eyes of predetermined viewers.

Such time multiplex composite input video stream signal VSS comprises a periodic sequence of pairs of view frames carrying pixel data of two dimensional (2D) left and right eye views Vlij and Vrij of a 3D image IMij, in which i=1, 2 . . . K, being the number within a sequence of K 3D images constituting video programme j, in which j=1, 2 . . . M, M being the total number of 3D TV programmes, which are supplied via an input signal processor 10 to an image source 12 of a display device DD. The image source 12 converts the electrical pixel data from the input signal processor 10 into optical pixel data carried by light beams or rays, emitted to the rear end of socalled directivity optics 14 located in front of the image source 12. The input signal processor 10 simultaneously supplies view index data i,j of said left and right eye views Vlij and Vrij to a directivity driver 16 for synchronizing the operation of the display device DD with the supply of these views to the image source 12.

The autostereoscopic image display system also comprises a viewpoint tracker VT having a 3D eye localisator 18 for detecting the xyz coordinates of all viewer eyes individually within the viewing range of the display device DD. Such viewpoint tracker VT is on itself known e.g. from European Patent 0 946 066. The 3D eye localisator 18 is coupled to a view point control signal generator 20 providing a view point indicative control signal to the directivity driver 16. The directivity driver 16 generates a direction control signal using the view index data i,j and said view point indicative control signal, which is supplied to the directivity optics 14 of the display device DD. Under control of said direction control signal, the directivity optics 14 focus the lightbeams carrying pixel data of the left and right eye views Vlij and Vrij to the corresponding eyes of a predetermined observer or viewer n authorised to view the above video or TV programme j. More in particular, the image source 12 emits light only in one specific direction (all light rays are parallel). In front of the image source 12 are directivity optics 14, that can change the direction of the light rays in order to enter one, several, or all viewers eyes. The directivity driver 16 decides for each of the eyes independently whether it can see the display or not. The 3D eye localisator 18 provides the directivity driver 16 with xyz coordinates of all eyes, so that the directivity optics 14 can properly be adjusted by the directivity driver 16.

For the sake of clarity, the invention shall be described with reference to FIGS. 2A and 2B on the basis of a single 3D video or TV programme being constituted of a series of 3D images IM1 to IMK, which is to be transmitted to three observers or viewers VP1-VP3. Suppose each of the 3D images IM1 to IMK consists of 2D left and right eye views Vl1 to VlK and Vr1 to VrK, respectively, supplied by the image source 12 in an alternate sequence of even and odd view frames occurring in even time slots t=0, 2, 4, . . . and odd timeslots t=1, 3, 5, . . . , respectively, of the above time multiplex composite input video stream signal VSS. Then in said even timeslots the display device DD is set in a left view mode to deal with left eye views Vli (i=1 . . . K) only, as shown in FIG. 2A. In said odd timeslots the display device DD is set in a right view mode to deal with right eye views Vri (i=1 . . . K) only, as shown in FIG. 2B. For the display of a single 3D image IMk, the 2D left and right eye views Vlk and Vrk thereof occurring in timeslots 2(k−1) and 2k−1 respectively, the directivity driver 16 controls the directivity optics 14 to focus all lightbeams carrying pixel data of said left eye views Vlk in said even timeslot 2(k−1) into a left view focus point or apex coinciding with the left eye viewpoints of observers VP1-VP3 and to focus all lightbeams carrying pixel data of said right eye views Vlk in said odd timeslot 2k−1 into a right view apex coinciding with the right eye viewpoints of said observers VP1-VP3. Synchronisation in the alternate switching of the display device DD from the left view mode into the right view mode and vice versa, with time multiplexed transmission of the 2D left and right eye views Vli and Vri from the image source 12 to the directivity optics is achieved with the view index data i supplied by the input signal processor 10 to the directivity driver 16. By using the above view point indicative control signal provided by the viewpoint tracker VT to dynamically adapt the left and right view apex to the actual position of the eyes of each viewer, a correctly distinct focus of the 2D left and right eye views Vl and Vr of all 3D images IM1 to IMK to the eyes of each of the viewers VP1-VP3 is obtained, resulting in a correct 3D image perception of the complete 3D video or TV programme at all three view points VP1-VP3, independent from the viewers position and movement within the viewing range of the display device.

FIG. 3 shows in more detail an embodiment of the above display device DD according to the invention. The image source 12 includes an image plane 22, an image lens 24 and a Fresnel lens 26. The image plane 22 emits lightbeams, which may be diffused, carrying pixels of 2D left and right eye views Vli and Vri in mutual alternation through the image lens 24 and the Fresnel lens 26 to the directivity optics 14. The image lens 24 converts the lightbeams coming from the image plane 22 into a divergent set of lightbeams towards the Fresnel lens 26. The Fresnel lens 26 converts the divergent light beams of the image projector consisting of the image plane together with the image lens 24 into parallel lightbeams, also being referred to as collimated light. The directivity optics 14 comprises sequentially in downstream light direction a parallax barrier 28, a lenticular screen 30 with an array of vertical columns of cylindrical lenses operating as horizontal diffuser capable of diffusing light horizontally and a similar lenticular screen 32 positioned orthogonal to the lenticular screen 30, therewith functioning as vertical diffuser capable of diffusing light vertically. The two lenticular screens 30 and 32 operate separately in the horizontal and vertical diffusion and comprise each an array of lenses arranged in columns or strips with a width in the order of magnitude of pixel-width. Preferably, the width of the lenses is chosen to correspond to 0.3-1 times the pixel width. Each strip diffuses light within a diffusion angle, which for the lenticular screen 30 may be larger than for the lenticular screen 32, as a wide viewing angle is more important in the horizontal direction than in the vertical direction. The vertically diffusing lenticular screen 32 is fixed and can be used to increase brightness of projection for viewpoints within a certain vertical range at the expense of the brightness of projection for viewpoints beyond said certain vertical range. Preferably this range is chosen to cover substantially all most likely vertical viewpoint positions. Instead of being positioned between the horizontally diffusing lenticular screen 30 and the viewers, the vertically diffusing lenticular screen 32 may alternatively be positioned between the parallax barrier 28 and horizontally diffusing lenticular screen 30, or before both the parallax barrier 28 and the horizontally diffusing lenticular screen 30. The use of the lenticular screen 32 is optional, reason for which it is omitted from the description of the invention as given hereinafter.

The parallax barrier 28 is provided with a pattern of vertical slits S, which are light transmissive and mutually separated by adjustable opaque barrier regions. The width of the slits S is chosen substantially smaller than the width of a pixel, hereinafter being referred to as subpixel width. Despite the smaller width, each lightbeam passing through a slit carries the full data of a single pixel. The slits therewith effectuate pixel sampling. With the above preferred choice of the width of the lenses at 0.3-1 times the pixel width the distance between the samples at the image reconstruction is sufficiently small to avoid unwanted effects (such as e.g. moire) from occurring. The lightbeams transmitted through the slits S of the parallax barrier 28 to the array of lenses of the lenticular screen 30, can be divided into groups of lightbeams allocated to the pixels of the image. The lightbeams within each such group each carry an identical sample of one and the same pixel. Said adjustable opaque barrier regions allow for a control of the vertical slits S to either block or transport light, therewith enabling the control of the horizontal diffusing characteristics, and additionally to accurately align the slits S with the lenses of the lenticular screen 30, i.e. for an accurate positioning of the location of incidence of the collimated lightbeams received from the Fresnel lens 26 into the lenses of said lenticular screen 30. Preferably the parallax barrier is being provided with a number of slits per lens width in the order of 10 to 1000, or in other words the pitch of the slits is chosen such that the number of slits per lens width is in the order of 10-1000.

When the slits S of the parallax barrier 28 are fully open (all light passes), the collimated light from the Fresnel lens 26 is diffused in each cylindrical lens of the lenticular screen 30 in all horizontal vertical directions. This is shown for a single lens of the lenticular screen 30 in FIG. 4A. All viewers can then view the 2D left and right eye views Vlk and Vrk of a 3D image IMk simultaneously without distinction between these views, resulting in an overall 2D image display (no 3D effect). The displayed 2D image is being perceived as originating from the location of the lenticular screen 30.

To display 3D images according to the invention, the slits of the parallax barrier 28 are adjusted in width and lateral position with regard to the lenses of the lenticular screen 30, such that the collimated light beams passing through the slits of the parallax barrier 28 will enter the corresponding lenses at the right spot of incidence to cause a specific, controlled angle βs of refraction of said lightbeams as shown in FIG. 4B.

The specific slit pattern and locations needed for the lightbeams carrying the pixel data of the sequentially occurring left and right eye views of a 3D image to arrive at the correct angle of refraction for displaying said left and right eye views into a very specific direction in space is calculated in the directivity driver 16. The parallax barrier 28 blocks some of the light beams received from the Fresnel lens 26 and the 3D image is only shown in a very specific direction β_{S}. The image intensity or image brightness is unaltered in this direction. The calculation is based on the lightbeams within each above group entering the slits of the parallax barrier 28 in mutually parallel direction.

Deviations α_{LS} from the orthogonal angle of incidence give rise to deviations α_{S} from the wanted angle βs of refraction of said lightbeams and therewith to blurring effects in the left and right eye view focus. Such deviations, when being small, may be acceptable. The size of the angle α_{S} depends on the spread in angle of incoming rays α_{LS}, and the resolution (width Δx of the slits S) of the parallax barrier 28, as will be explained in more detail with reference to FIG. 7.

If said deviations α_{LS} are small, then the incoming lightbeams of the parallax barrier 28 enter the slits S of the parallax barier 28 in substantially parallel direction being orthogonal to the parallax barrier 28. The angle β of each diffused lightbeam is directly defined by the sub-pixel position x in [−½,½] of the corresponding lightbeam entering the lens of the lenticular screen 30, as shown in FIG. 4A. The material and shape of the lenses determine the function β_{S}(x), that describes how the angle of an outgoing light beam depends on the position x of the incoming light beam.

Via the parallax barrier 28 incoming lightbeams at arbitrary positions x can be blocked, therewith controlling the direction β_{S} of the outgoing lightbeams. This allows for a viewer and image selective display of 3D images or 3D video or TV programmes.

FIG. 5A shows slits S11 and S12 of the parallax barrier 28 occurring in an even timeslot and transmitting lightbeams LB11 and LB12, respectively, each carrying a sample of a common pixel of the above left eye view Vlk of a 3D image Vk. The directivity driver 16 controls the opaque barrier regions of the parallax barrier 28 and therewith the slits S11 and S12 such, that the spot of incidence of the lightbeams LB11 and LB12 into lens L is located correctly to obtain angles of refraction β11 and β12 within the lens causing the outgoing lightbeams LB11 and LB12 to converge into the intended left eye view locations of viewers VP1 and VP2 respectively. FIG. 5B shows slits Sr1 and Sr2 of the parallax barrier 28 occurring in an odd timeslot and transmitting collimated lightbeams LBr1 and LBr2, respectively, each carrying a sample of a common pixel of the above right eye view Vrk of a 3D image Vk. The directivity driver 16 controls the opaque barrier regions of the parallax barrier 28 and therewith the slits Sr1 and Sr2 such, that the spot of incidence of the lightbeams LBr1 and LBr2 into lens L is located correctly to obtain angles of refraction βr1 and βr2 within the lens causing the outgoing lightbeams LBr1 and LBr2 to converge into the intended right eye view locations of viewers VP1 and VP2 respectively. For such control, the directivity driver 16 calculates the exact spot of incidence on the basis of a.o. the refraction function of the horizontal diffusor lenses (refraction angle as a function of subpixel position of collimated light rays). Parameters needed for such calculation are a.o. lens material, lens shape, and refraction index, which together determine the refraction function. In order to block out predetermined viewers (e.g. non subscribers) from watching certain images (e.g. pay channels) the directivity driver 16 comprises viewer selective means controlling the parallax barrier to block the transmission of pixel carrying lightbeams to one or more predetermined viewpoints.

FIG. 6 shows the operation of the directivity optics 14 in displaying various pixels of a single eye view. As mentioned above, the directivity optics 14 comprise the above mentioned adjustable parallax barrier 28 with a vertically pattern of slits and the linear lens array of said lenticular screen 30, aligned with the parallax barrier 28 and capable of diffusing light horizontally. The lens array have been given a pitch that is comparable to the display resolution.

Whenever the parallax barrier 28 presents a specific striped pattern of slits, e.g. slits Si0-Si2, light will travel only in a specific, controlled direction pattern as given in this FIG. 6 providing several pixels of a single eye view to an observer. The directivity driver 16 calculates the barrier pattern needed to cause outgoing light rays converging to the intended eye locations. A set of different images is transmitted sequentially to the display device DD, while the parallax barrier 28 is continuously adapted to direct each of the images into a very specific direction. The average brightness of the image displayed is reduced by a factor equal to the number of different images.

FIG. 7 shows an implementation of the image source 12 for use in an autostereoscopic image display apparatus according to the invention comprising image plane 22 and image lens 24 emitting pixels of an eye view to the directivity optics 14, comprising the parallax barrier 28 and the lenticular screen 30. The dotted lines in the figure show the light beams carrying image data related to a single pixel. Lightbeams having a propagation direction in the area v between the image projector 22 and the image lens 24 deviating over an the angle α_{IL} from a longitudinal center axis transversely to the plane of the image lense 24, will through refraction in the image lens 24 change in propagation direction to form an angle in the area b between the image lens 24 lens and screen of α_{LS}. The lightbeams going out from the lenticular screen 30 of said directivity optics 14 deviate from the wanted direction over an outgoing angle α_{S} (see also FIG. 4B). By choosing v<<b the angle α_{LS} will be very small since:

$${α}_{LS} \approx {α}_{IL} \frac{v}{b} \qquad ( 1 )$$

The smaller the angle α_{LS} and/or the higher the slit resolution (i.e. the smaller the width Δx of the slits S) of the parallax barrier 28, the smaller the deviation angle α_{S} of the outgoing lightbeam and the smaller the blurring effect in the focus of the pixel carrying lightbeams at the eye of the observer. The size of the viewing angle, α_{S}, depends on the spread in angle of incoming rays α_{LS}, and the slit resolution of the parallax barrier 28 as follows:

α_{S}=β′_{S}(x)Δx+α_{LS}+αₗₑₙₛ (2)

The additional term αₗₑₙₛ models slight diffuse characteristics of the lenses. The total viewing angle of the display is:

γ_{S}=β_{S}(½)−β_{S}(−½) (3)

For the number of independend views within this total viewing angle we then find:

$$N = \frac{{γ}_{S}}{{α}_{S}} \qquad ( 4 )$$

The brightness of the rays in each direction given by (2) is proportional to:

$$I ∝ \frac{1}{{β}_{S}^{′} ( x ) cos {β}_{S} ( x )} \qquad ( 5 )$$

Most of the outgoing light is leaving from a relatively small area of the respective lenses of the lenticular screen 30. At the other area of the lens, where no light is leaving, glue can be used for construction purposes or dark paint to prohibit reflection of light at the viewer side (a similar technique is used in current projection displays).

In the autostereoscopic image display system according to the invention as shown in FIG. 3 and further detailed in FIGS. 4 to 7, a time multiplexed display of left and right eye views of a 3D image to a number of viewers reduces the average image brightness due to said time multiplex mode of display by a factor of only 2, regardless of the number of viewers.

Practical dimensions for such autostereoscopic image display system according to the invention are as follows:

For the image plane 22, image lens 24 and the Fresnel lens 26 use can be made of Philips' LCOS system, in which the above angle α_{IL} is very small as a parallel light source is used. Via (1), it appears that α_{LS} is negligible. For the lenticular screens 30 and 32 of the display device DD, a screen size of 1 m+1 m with resolution 1000×1000, an average viewing distance dᵥ of 3 m and an inter-eye distance d_{eye} of 6.5 cm. This results in a pixel size of 1 mm².

Lenticular screens which can be used for the lenticular screens 30 and 32, have already been manufactured by Philips with substantial size (e.g. 10-20 inch) and have been used in lenticular displays with LCD, such as known from C. van Berkel, “Image preparation for 3D-LCD”, SPIE Proceedings 3639, pp. 84-91, 1999. In this application, the lenticular lenses have the shape of part of cylinder, providing only a small viewing angle. For use as lenticular screens 30 and 32 functioning as horizontal and vertical diffuser respectively, it is possible to use any shape, such as a full cylinder, providing a much bigger viewing angle. For full cylinder-shaped lenses, the refraction function is given by:

$${β}_{S} ( x ) = 2 ( {sin}^{- 1} 2 x - {sin}^{- 1} 2 \frac{x}{n} ) \qquad ( 6 )$$

Here n is the refractive index of the lens material. For n≈1.5 (glass), the total viewing angle γ_{S} is about 180°, however then the brightness distribution (5) is quite non-uniform (+/−2 dB). Suppose n≈2 (crystal), and set a maximum

|x|≦0.45 (7)

About 10% of each pixel is then unused, which as already mentioned above can be used e.g. for manufacturing purposes or for construction strengthening. This limitation also eliminates an unwanted increase in the brightness distribution at the extreme viewpoints, leaving an overall viewing angle of:

γ≈140° (8)

while the brightness is uniform (+/−0.35 dB) within this angle.

For the parallax barrier 28 with a size and a number of vertical stripes equal to the number of pixels times the required resolution of 1/Δx per pixel, a size or width of Δx being defined as follows.

$${α}_{S} = {β}_{S}^{′} ( x ) Δ x \approx \frac{{140}^{∘}}{2 \cdot 0.45} Δ x \approx {156}^{∘} Δ x \qquad ( 9 )$$

The inter-eye distance and viewer distance with regard to the lenticular screens 30 and 32 result in a minimal angular view resolution:

$${α}_{S} < {tan}^{- 1} \frac{1}{2} \frac{{d}_{eye}}{{d}_{v}} \approx {0.6}^{∘} \qquad ( 10 )$$

According to (4):

$$Δ x < \frac{{0.6}^{∘}}{{156}^{∘}} \approx \frac{1}{260} [ pixel ] \approx 4 μm \qquad ( 11 )$$

A practical embodiment of the parallax barrier 28 can implemented on the basis of Philips' Polymer LC/gel layers with substantial size (e.g. 10-20 inch) and capable to be switched electronically between transparent and opaque states at high rates (as in H. de Koning, G. C. de Vries, M. T. Johnson and D. J. Broer, “Dynamic contrast filter to improve the luminance contrast performance of cathode ray tubes”, in IDW′00 Proceedings of 7th International Display Workshop, 2000). In the layer, arbitrary patterns can be made via a lithographic process. This results in high horizontal resolution which may be in the order of magnitude of about 0.005 pixel width.

When the parallax barrier 28 of this practical embodiment of an autostereoscopic image display system according to the invention is turned to the completely transparent state, the system functions as a conventional 2D image projection display system. The parallax barrier 28 and lenticular screen 30 forming a single, flat device. This enables easy mounting on existing projection displays, and existing LCDs (with collimated backlight).

As the incoming light at the lenticular lenses screens 30 and 32 is highly conditioned (collimated), the design of the lens shape of the lenticular screens 30 and 32 can be done with a high degree of freedom. The lenses do not need to comply with the socalled thin lens formula that e.g. assigns the lens a well-defined focal length f such as needed in current lenticular displays. The only requirement is that β_{S} can be varied substantially (ideally from −90° to +90°), and that no or few diffuse reflections within the material occur (αₗₑₙₛ≈0).

In the above embodiment circular lenticular lenses were used. These can be easily made depending on the material used (e.g. glass fibres). Several other types of lenses may be used to improve the performance or to simplify the production process.

FIG. 8 shows an alternative embodiment of the image source 12 based on the use of a collimated backlight source 34 and a transmissive image display, e.g. LCD, screen 36. Herein, the collimated backlight source 34 transmits lightbeams to the transmissive image display screen 36, in which the lightbeams are modulated with pixel data. The collimated backlight source 34 may be implemented by a laser device, a directive light source emitting light going in only one direction, e.g. a flash light or, alternatively, by a conventional, diffuse lightsource (e.g. a normal light bulb, LEDs ) in combination with a lens, such as the Fresnel lens 26 in FIG. 3. The parallax barrier 28 (not shown) can be located either between the transmissive image display screen 36 and the viewers or between backlight source 34 and said transmissive image display screen 36.

FIG. 9 shows a cross section of a lens shape for use in the array of lenses L of the lenticular screen 30 and/or 32. The width of these lenses has been chosen to correspond in order of magnitude to the width of a pixel. Practical values are as mentioned above 0.3-1 times the pixel width.

As some parts at the sides of the lenses are not used, these parts can be used e.g. to glue the lenses together, or used otherwise in the manufacturing process. This results in opaque glue stripes mutually separating the useful area of the lenses of the lenticular screen in question. To prevent a limitation in viewing angle and/or loss of brightness these opaque glue stripes are chosen sufficiently small compared to the lens width, preferably e.g. 0-20% of the lens width.

FIG. 10 shows a signal frame structure of the above time multiplex composite input video stream signal VSS comprising sequential time slots for a time multiplex transmission of three 3D video or TV programmes. In the example given, time slot t1 comprises pixel data of a two dimensional (2D) left eye view Vli1 of 3D image IMi1 (i.e. 3D image i of a first video or TV programme), sequentially followed by timeslot t2 comprising pixel data of a two dimensional (2D) left eye view Vli2 of 3D image IMi2 (i.e. 3D image i of a second video or TV programme) and by timeslot t3 comprising pixel data of a two dimensional (2D) left eye view Vli3 of 3D image IMi3 (i.e. 3D image i of a third video or TV programme). Timeslot t3 is followed by timeslot t4 comprising pixel data of a two dimensional (2D) right eye view Vri1 of the said 3D image IMi1, which timeslot t4 is sequentially followed by timeslot t5 comprising pixel data of a two dimensional (2D) right eye view Vri2 of said 3D image IMi2 and by timeslot t6 comprising pixel data of a two dimensional (2D) right eye view Vri3 of said 3D image IMi3. Time slot t6 is sequentially followed by time slot t7 comprising pixel data of a two dimensional (2D) left eye view Vl(i+1),1 of 3D image IM(i+1),1 (i.e. 3D image (i+1) of said first video or TV programme), by timeslot t8 comprising pixel data of a two dimensional (2D) left eye view Vl(i+1),2 of 3D image IMi2 (i.e. 3D image (i+1) of said second video or TV programme), by timeslot t9 and so forth and so on. Time slot t1 is preceded by timeslot t0 comprising pixel data of a two dimensional (2D) right eye view Vr(i−1),3 of 3D image IM(i−1),3 (i.e. 3D image (i-1) of said third video or TV programme), and so forth and so on.

The scope of the invention is not limited to the embodiments explicitly disclosed. The invention is embodied in each new characteristic and each combination of characteristics. Any reference signs do not limit the scope of the claims. The word “comprising” does not exclude the presence of other elements or steps than those listed in a claim. Use of the word “a” or “an” preceding an element does not exclude the presence of a plurality of such elements.

For example, the shape of the individual lenses in the array of lenses of the lenticular screens 30 and 32 may differ in cross section from the circular or hemispherical shape mentioned above. Even lenses giving rise to some abberations may be used. However, for wide viewing angles, e.g. in the order of magnitude of 140 degrees, circular shaped lenses (fibers) may preferably be used.

1. Autostereoscopic image display apparatus comprising a display device including an image source emitting lightbeams carrying pixels of right and left eye views of a 3D image to a lenticular screen having an array of lenses for displaying said 3D image, a parallax barrier being located between the image source on the one hand and the lenticular screen on the other hand, said parallax barrier being provided with an array of light transmissive slits separated by opaque regions for transmitting said lightbeams to the array of lenses of said lenticular screen, and a viewpoint tracker detecting right and left eye positions and tracking said display device therewith, characterized by said viewpoint tracker controlling the slits of the parallax barrier to vary the incidence of said lightbeams into the lenses to effect an angle of refraction within said lenses causing the outgoing lightbeams carrying pixels of said right and left eye views to converge into at least one distinct right and one distinct left eye view focus, respectively, coinciding with said detected right and left eye positions.

2. Autostereoscopic image display system according to claim 1, characterized by the slits of the parallax barrier having subpixel width.

3. Autostereoscopic image display system according to claim 1, characterized by the lenses of the lenticular screen having a width substantially greater than the width of the slits of the parallax barrier.

4. Autostereoscopic image display system according to claim 3, characterized by the lenses of the lenticular screen having a width corresponding substantially to 0.3-3 times pixel width.

5. Autostereoscopic image display system according to claim 1, characterized by the parallax barrier being provided with a number of slits per lens width in the order of 10 to 1000.

6. Autostereoscopic image display system according to claim 1, characterized by the array of lenses of the lenticular screen forming vertical columns of lenses mutually optically separated by opaque vertical stripes each having a width smaller than the width of the lenses of the lenticular screen.

7. Autostereoscopic image display system according to claim 1, characterized by the lenses within the array of lenses of the lenticular screen having a hemispherical cross section.

8. Autostereoscopic image display system according to claim 7, characterized in that each lens within the array of lenses of the lenticular screen has a viewing angle greater than 100 degrees.

9. Autostereoscopic image display system according to claim 1, characterized by a Fresnel lens being disposed between said image device and said parallax barrier.

10. Autostereoscopic image display system according to claim 1, characterized in that the image source comprises a collimated backlight source.

11. Autostereoscopic image display system according to claim 1, characterized in that the parallax barrier is of an LCD type.

12. Autostereoscopic image display system according to claim 1, characterized in that the parallax barrier is of a Polymer LC/gel type.

13. Autostereoscopic image display system according to claim 1, characterized by the array of lenses of said lenticular screen forming a horizontal diffusor with vertical columns of lenses, said display device also comprising a vertical diffuser consisting of a number of horizontal columns of lenses having a width substantially equal to the width of the lenses of the lenticular screen forming said horizontal diffusor, said vertical diffuser being positioned either behind or in front of said horizontal diffuser.

14. Autostereoscopic image display system according to claim 1, characterized by said viewpoint tracker detecting eye positions of various viewers, the individual lenses of the lenticular screen receiving lightbeams from a number of slits being determined by the number of detected viewers.

15. Autostereoscopic image display system according to claim 1, characterized by the right and left eye views of said 3D image being emitted by the image source in time multiplex.

16. Autostereoscopic image display system according to claim 1, characterized by viewer selective means controlling the parallax barrier to block the transmission of pixel carrying lightbeams to one or more predetermined viewers.

17. Autostereoscopic image display system according to claim 1, characterized by said image source providing various 3D TV programs in time multiplexed 3D images, each 3D image thereof being projected at the right and left eyes viewpoints of a number of observers by an angle of refraction within said lenses controlled by said viewpoint tracker through an adjustment of the slits of the parallax barrier to vary the incidence of said lightbeams into the lenses.

18. Display device for use in an autostereoscopic image display system according to claim 1.
